(19) United States
(12) Patent Application Publication
(10) Pub. No.: US 2009/0030783 A1
(43) Pub. Date: Jan. 29, 2009

(54) REWARDING BASED ON USER OFFLINE AND ONLINE CHARACTERISTICS

(76) Inventor: Ruediger Hans-Joachim Schloo, Muenster (DE)

Correspondence Address: GREENBLUM & BERNSTEIN, P.L.C., 1950 ROLAND CLARKE PLACE, RESTON, VA, 20191, US

(21) Appl. No.: 11/828,176

(22) Filed: Jul. 25, 2007

(51) Int. Cl. G06Q 30/00

(52) U.S. Cl. 705/14; 705/1

(57) ABSTRACT

Method, computer readable medium and device for collecting and forwarding data is disclosed. The collected data is associated with user input to a first user interface, when a first user associated with the first user interface is offline and a predetermined application hosted by the first client interfaces with a user by accepting the user input. The collected data associated with user input to the first user interface is forwarded when the first client is online. The collected data associated with user input to the first user interface is analyzed to determine characteristics of the user. The instant abstract is neither intended to define the invention disclosed in this specification nor intended to limit the scope of the invention in any way.

### BACKGROUND OF THE INVENTION

1. Field of the Invention

A computer user's characteristics are collected and used to offer products, services and incentives to obtain vouchers, discounts, prizes and rewards.

2. Discussion of the Background Information

The above-described offers can be based on data relating to a computer user's characteristics associated with online activity. Insofar as a computer may be used for many offline activities, commercially valuable data relating to a computer user's characteristics associated with such offline activities is not collected and used to offer products, services and incentives to obtain vouchers, discounts, prizes and rewards.

Computers are often used to perform offline work activities. Incentives for offline work activities could be used to increase quantity and/or quality of offline work activities. Such incentives could be provided if data relating to a computer user's characteristics associated with offline activities is collected and used to offer products, services and incentives to obtain vouchers, discounts, prizes and rewards.

Therefore, it is desirable to collect data relating to a computer user's characteristics associated with offline activities, including when the computer is used for offline activities though the computer is online.

### SUMMARY OF THE INVENTION

According to an aspect of the present disclosure, a method for collecting user information includes collecting data associated with user input to a first user interface, when a first client associated with the first user interface is offline and a predetermined application hosted by the first client interfaces with a user by accepting the user input. The method also includes forwarding the collected data associated with user input to the first user interface, when the first client is online. The collected data associated with user input to the first user interface is analyzed to determine characteristics of the user.

In embodiments, the collected data associated with user input to the first user interface includes data that is characteristic of the user input to the first user interface.

In other embodiments, the collected data associated with user input to the first user interface includes data that is characteristic of usage of a predetermined application.

In still other embodiments, the data collection includes monitoring activities such as keystrokes, screen touches, touchpad touches, mouse movements, mouse clicks, trackball movements, trackpoint clicks, light pen movements, joystick movements, joystick button clicks, gamepad touches, analog stick movements, and touchless interface operations etc. Furthermore, the data collection includes activities such as monitoring the opening of software, exiting software, powering peripheral devices, and a length of time user input is input to the user interface.

In other embodiments, the collected data associated with user input to the first user interface is compared with collected data associated with user input to a second user interface associated with a second client.

In other embodiments, the collected data associated with user input to the first user interface is used to determine a reward for the user based on the comparison with collected data associated with user input to the second user interface. Therefore, the results of the monitoring of user characteristics of different users can be implemented in various types of reward granting applications, e.g., internet lotteries, achievement rewards, or random rewards weighted on the numbers of keystrokes and/or mouse movements etc., or on usage of software.

In yet another embodiment, the collected data associated with user input to the first user interface is used to generate a score with a predetermined threshold.

According to an aspect of the present disclosure, the collected data associated with user input to the first user interface can be used to determine a reward for the user based on a comparison with the predetermined threshold.

According to another aspect of the present disclosure, the forwarding includes generating a code segment based on the collected data associated with user input to the first user interface.

According to still another aspect of the present disclosure, the method includes rewarding the first user based on the determined characteristics of the user.

According to another aspect of the present disclosure, a computer readable medium includes a collecting segment that collects data associated with user input, to a first user interface, when a first client associated with the first user interface is offline. The computer readable medium further includes a forwarding segment that forwards the collected data associated with user input to the first user interface when the first client is online. The collected data associated with user input to the first user interface is analyzed to determine characteristics of the user.

In embodiments, the collecting segment of the computer readable medium collects data characteristic of the user input to a first user interface.

In further embodiments yet, the collecting segment of the computer readable medium collects data characteristic of usage of the predetermined application.

In embodiments, the collecting segment monitors activities such as keystrokes, screen touches, touchpad touches, mouse movements, mouse clicks, trackball movements, trackpoint clicks, light pen movements, joystick movements, joystick button clicks, gamepad touches, analog stick movements, opening software, exiting software, powering peripheral devices, and a length of time of user input.

In additional embodiments, the computer readable medium includes a segment that forwards the collected data associated with user input to the first user interface to a second computer readable medium for comparison with data collected from a second client.

According to an aspect of the present disclosure, the computer readable medium includes a rewarding segment that informs the first user of a reward based on the comparison.

Yet in other embodiments, the computer readable medium includes a score generating segment for producing a score that is based on the collected data associated with user input to the first user interface.

The computer readable medium may also include a score comparing segment that evaluates a score with a predetermined threshold.

According to another aspect of the present disclosure, a device includes at least one user interface. The device also includes a collector that collects data associated with user input to the at least one user interface when the device is offline. The device further includes a forwarder that forwards the collected data associated with user input to the first user interface when the device is online. The collected data associated with user input to the first user interface is analyzed to determine user characteristics.

According to an aspect of the present disclosure, the collector is set up to accumulate data that is characteristic of the user input to a user interface.

In other embodiments, the collector of the device accumulates that is characteristic of the usage of a predetermined application.

The device monitors keystrokes, screen touches, touchpad touches, mouse movements, mouse clicks, trackball movements, trackpoint clicks, light pen movements, joystick movements, joystick button clicks, gamepad touches, analog stick movements, touchless interface operations, opening software, exiting software, powering peripheral devices, and a length of time of user input or usage of a predetermined application.

In embodiments, the device includes a score generator that compares scores with a predetermined threshold.

Yet in other embodiments, the device includes an analyzer that compares the score with the predetermined threshold or with scores generated and forwarded from other devices.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 depicts a flow chart illustrating an exemplary method for collecting and forwarding user characteristics for computer rewarding based on user offline characteristics;

FIG. 2a depicts a diagram illustrating an exemplary network used to implement rewarding based on user offline characteristics;

FIG. 2b depicts a flowchart illustrating an exemplary method for analyzing eligibility for rewards based on forwarded data;

FIG. 3 depicts an exemplary interface used for rewarding based on user offline characteristics; and

FIG. 4 depicts an exemplary client processor used for rewarding based on user offline characteristics;

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following description, reference is made to the accompanying drawings, which form part hereof and in which is shown specific exemplary embodiments. These embodiments are described in sufficient detail to enable those skilled in the art to practice rewarding based on user offline characteristics, and it is to be understood that other embodiments may be utilized and that logical, mechanical, electrical and other changes may be made without departing from the scope of the present disclosure.

The description of the various embodiments is to be construed as exemplary only and does not describe every possible instance of rewarding based on user offline characteristics. Numerous alternatives could be implemented, using combinations of current or future technologies, which would still fall within the scope of the claims. The following detailed description is, therefore, not to be taken in a limiting sense, and the scope of the present disclosure is defined only by the appended claims.

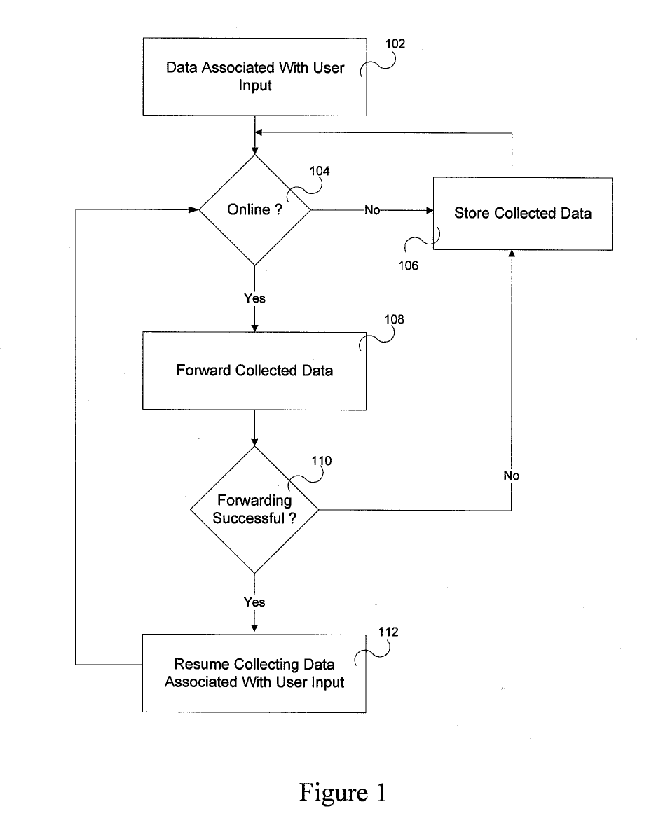

FIG. 1 depicts a flow chart illustrating an exemplary method for collecting and forwarding user characteristics for computer rewarding based on user offline characteristics. Initially, a user interacts with a software-based application hosted by a client. Data associated with user input is collected at 102. The software-based application receives user input through an interface associated with the client as collected data. The collected data may include any data to the interface. The user interface includes an alpha-numerical type key board, a mouse, an alpha-numerical touch screen or any other device used by a user to input information to interact with a software-based application hosted by a client. Without limiting the scope of the present disclosure, the data collection also includes monitoring keystrokes, screen touches, touchpad touches, mouse movements, mouse clicks, trackball movements, track point clicks, light pen movements, joystick movements, joystick button clicks, game pad touches, analog stick movements, and touchless interface operations etc. Furthermore, the collected data associated with user input can be associated with any software resident on the client usable online or offline, or internet based products accessed by the client. Without limiting the scope of the present disclosure, the associated software may include any word processing program, spreadsheet program, email program, web browser, file management software, seminar presentation software, publishing software, office management programs, peripherals application software, software obtained from online services, and imaging software.

Still referring to FIG. 1, the client sporadically tests for online connection at 104. Sporadic tests can be achieved by frequently testing for an online connection, e.g., every minute, hour, day; but also by testing for an online connection every time the user works with the client, for example, a device is turned on or a software application is opened. If the client is online, the method proceeds with the forwarding as described below. If the client is not online, the collected data is stored in any suitable memory device at 106 and made available for later forwarding at 104 when the client is online.

Once the client establishes online connection, any data stored in the suitable memory device can be forwarded at 108 to the remote location, e.g., a remote server prepared and adapted to receive the previously stored and collected data. Further, while online, the collected data associated with user input to a user interface of the client can be forwarded at 108 to the remote location, e.g., a remote server prepared and adapted to receive the previously stored and collected data. After the data has been transmitted, a check can be performed at 110 to ensure complete transmission of the collected data between the client's user interface and the remote server. Any method for checking complete transmission can be used.

If the forwarding of the data has completed successfully, the client's user interface may resume data collection at 112, and the newly collected data can be transferred at a later point in time, when the client is online again. If the forwarding is not successful for any reason, for example due to transmission interruption or loss of online connection, all the data is stored at 106 for later forwarding at 108 and 110.

The frequency of data forwarding depends on the number of online connections available over the course of an application. In embodiments, data can be forwarded on a regular basis, thereby scheduling the forwarding to a specific time when the client is online. Alternatively, the data can be forwarded in real time, or on an irregular schedule such as when predetermined data collection parameters are met.

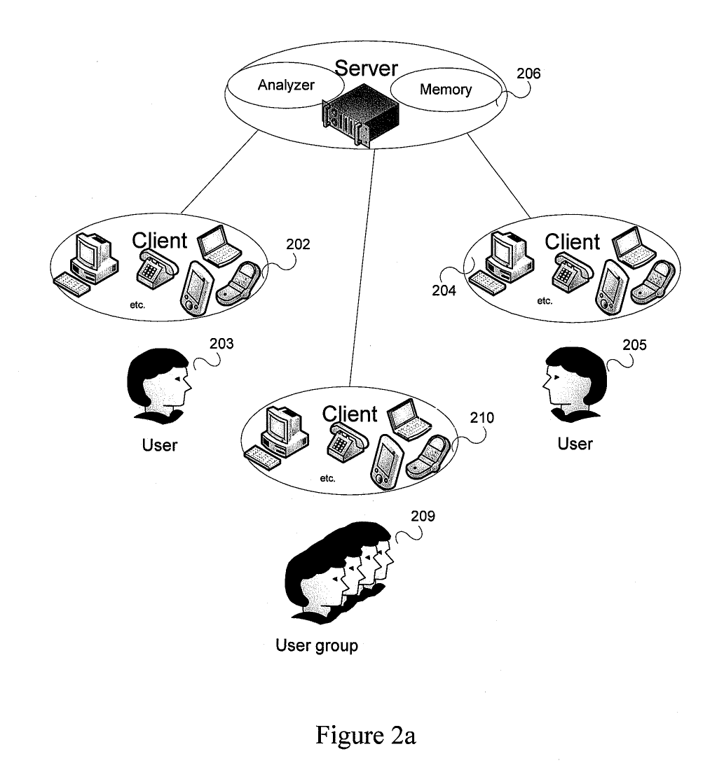

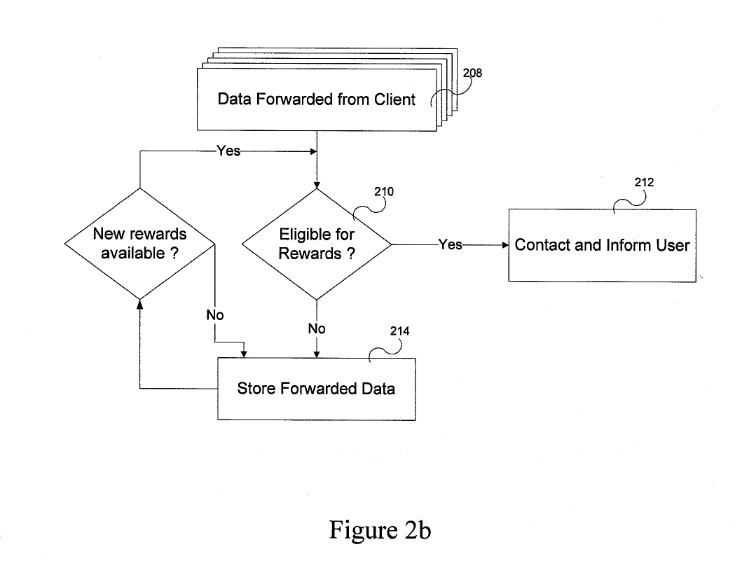

As depicted in FIG. 2a, data from client 202 or 204 can be forwarded to a remote location, e.g., a server (206). In embodiments, the server can be a centralized network server of an isolated network community, e.g. a business operation network or office network. In other embodiments, the server may include an internet server with access to a great number of internet users. Furthermore, the server may comprise a memory subsection for storing received data and/or an analyzer subsection for analyzing the received data from various clients. 202 or 204 may be any type of device with capacity for online or network communication, e.g., desktop or laptop computer, telephone, cell phone, PDA, scanner, copy machine, facsimile phone, video game box, video player and video recorder. Each client is 202, 204 associated with a user, for example, the client 202 can be associated with user 203, while client 204 can be associated with user 205.

Still referring to FIG. 2a, data from clients 202 and 204 can also be forwarded to the server 206 either concurrent or at different points in time. For example, the server 206 may receive and store the data from client 202 until the data from client 204 are received or a predetermined deadline has passed. The server 206 can analyze the collected data to determine characteristics of the users 203, 205 associated with clients 202, 204, respectively. According to the results of the analysis, the client 202 and/or the client 204 may be eligible for rewards. Any reward may be distributed to the clients based on the characteristics of the collected data. For example and without limiting the scope of the disclosure, rewards that may be distributed are winnings for a game competition, software upgrades to predetermined programs, gift certificates or vouchers for stores or websites according to the user characteristics, discounts, rebates, and any other prizes.

Moreover, in addition to the association of a single user, e.g., 203 or 205 with a specific client (204 and 206, respectively), the scope of the present invention also includes the association of a user group (209) with a client (210). For example, a client may be a home computer that is being used by all members of the family. Similarly, a client can be an office computer network that can be used by a number of office workers represented by the user group 209.

FIG. 2b illustrates a flowchart for analyzing the eligibility for any rewards. Data received from one or multiple clients can be collected at 208 and analyzed for reward eligibility at 210. This analysis can be based, for example, on reaching and passing a certain threshold value or on a comparison among forwarded data from a number of users. Upon determining that a reward may be granted to a user, the user is contacted and informed of the reward at 212. The user can be informed by any conventional method, e.g., by mail, email, phone call, SMS, announcement on a website or in case the client is online, by online contact, such as instant messenger, talk software, or online pop-ups. In case the data forwarded is not eligible for a reward, the data is stored 214 or any suitable storage device associated with the rewards determination software. The data can be stored at the server or any other device including the device from where the data originated for determining possible future eligibility for the user.

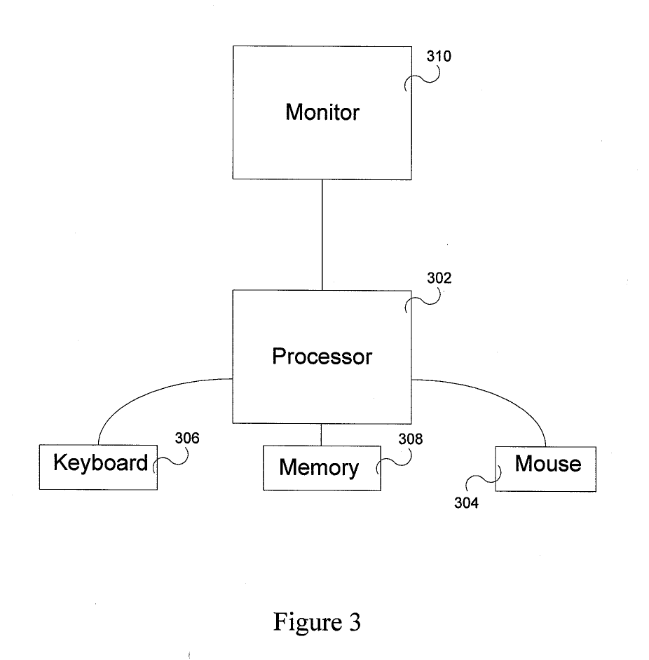

FIG. 3 represents a general user interface of a client including a processor (302), which collects data that is input through or by input devices, e.g., keyboard (306), mouse (304), or any other input device. The processor (302) can collect the data and store it temporarily in a memory device (308). The processor (302) can also sporadically check if an online connection is available for forwarding the data. Sporadic tests can be preformed frequently at predetermined time intervals, e.g., seconds, minutes, hours, days, etc. or whenever a device of the client is being used or a software application is opened. Additionally or alternatively, a signal can be sent to processor 302 when the user is online. Such a signal may be obtained from the internet server provider for the device. Furthermore, the processor delivers information via the monitor (310) about any rewards the user has received for the collected data, e.g. using Google™ word processor, i.e. “Google Docs & Spreadsheets™”.

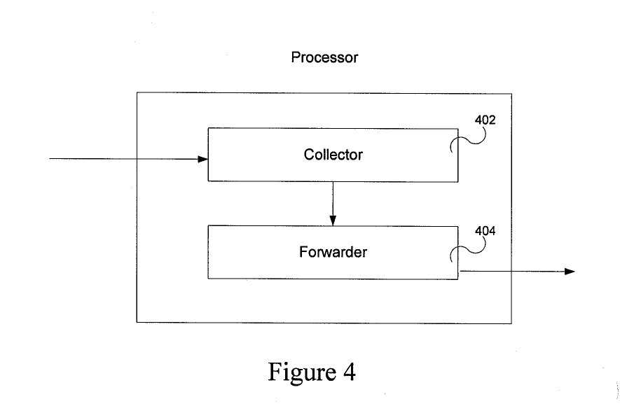

FIG. 4 represents elements of the processor. A memory device, e.g., a collector (402) stores the collected user input until the processor is online. This data can be stored in any association conventional software and/or hardware device. Some of the data can record the time that programs are used, other data refer to scores achieved in gaming programs, and other data monitor the type, amount and time spent with various programs to achieve a work product. Once the processor is online, the data is forwarded to forwarder (404). In embodiments, the forwarder can forward data to various addresses, such as that of the remote location. For example, if a user reached a new score in a gaming program, the forwarder submits the new score to an address adapted and set up to receive scores. Furthermore, in embodiments, the forwarder may receive information for a reward to the user, if the new score entitles the user to such a reward. Also in embodiments, the forwarder forwards data compiled from various programs to one address. For example, if the user spends a significant amount of time using word processing, spreadsheet programs and/or drawing programs, the data may be forwarded to an address adapted and set up to receive such information. Furthermore, the forwarder may receive information for a reward to the user regarding the use of such programs. For example, the reward may include an upgrade to the drawing program, or a discount for the next version of the spreadsheet program, or add-ons for the word processing software.

In embodiments, the collected data may be characteristic of the user input to a first user interface. Without limiting the scope of the disclosure, if the first user interface is a workplace computer, the data input by a worker can be characteristic of this worker associated with his job functions. In other embodiments, data collected by the home PC of a private person may be characteristic of such user. Likewise, a user who generally uses an interface for gaming purposes, the data collected may be characteristic of such user in the processor of the user interface containing the gaming software. Upon collection and forwarding the data, information can be transferred that shows characteristics, tendencies, and preferences of the user.

Furthermore, in embodiments, the data collected may be characteristic of the usage of a predetermined application. A predetermined application may include any software and/or hardware that is used by the user for offline activities. In embodiments the predetermined application can be any program in combination with any necessary hardware, for example and without limiting the scope of the disclosure, any word processing program, spread sheet program, gaming program, music or movie software.

In embodiments, the data that is collected includes input to a user interface that can be keystrokes, screen touches, touchpad touches, mouse movements, mouse clicks, trackball movements, trackpoint clicks, light pen movements, joystick movements, joystick button clicks, gamepad touches, analog stick movements. Furthermore, the collected data may include date relating to opening software, exiting software, types of software used, powering of peripheral devices, and the length of time an application is used.

Data from at least one other user interface that is associated with at least one second client can be collected. The collected data may be monitored, collected in the same fashion as at the first user interface and then forwarded. The forwarded data of the first and the at least one other user interface can be compared and a reward is determined base on the comparison. Without limiting the scope of the disclosure, several users may compete in a gaming competition, wherein each user reaches a certain score. Upon forwarding of the collected data in form of the scores, a champion can be determined, although the user interface is not online at all times.

Still in further embodiments, the present disclosure relates to a computer readable medium including a collecting segment that can collect data associated with user input to a first user interface, even while the first client is offline. The computer readable medium can further include a forwarding segment that forwards data, when the first client is online. Then, the collected data may be analyzed to determine characteristics of the user.

The collecting segment further can include also data collection that is characteristic of the user input to a first user interface. In embodiments, the data may be forwarded to a second computer readable medium for comparison with data collected from a second user interface. The computer readable medium may further include a rewarding segment that informs the first user via the first user interface of a reward based on the comparison with the second computer readable medium.

In addition to the data that is characteristic of the user, the collecting segment also collects data characteristic of multiple user. This type of data collection is important when a user interface is used from time to time and/or by different users, e.g., a home computer used by all family members, or an office computer shared by several employees.

In another embodiment, the computer readable medium can include a score generating segment that generates a score based on the collected data. The generated score can be used for comparison with a score generated from a second computer readable medium.

In yet another embodiment, the computer readable medium may include a score comparing segment that compares the score with a predetermined threshold. Activities involving two or more interfaces over a period of time can be compared, and when a first user interface generates a score higher than the predetermined score the higher score can become the predetermined score for the second user interface.

While rewarding based on user offline and/or online usage characteristics has been described in terms of embodiments, those skilled in the art will recognize that rewarding based on user offline characteristics can be practiced with modification within the spirit and scope of the appended claims.

### EXAMPLES

### Example 1

### The Home Gamer

A home computer user may use his computer mostly for gaming. The present invention collects relevant data to analyze the user's characteristics, e.g., preferred game genre, i.e., action games, adventure games, fighting games, role-playing games, simulation games, sport games, strategy games, etc.; preferred word processing, home/office products, etc., can be identified. Furthermore, it can be determined how much time the user spends per game/application and how often the user acquires a new game. Once the data collected and forwarded to a server or other device adapted to operate in accordance with the invention, e.g., to analyze of the user data, a determination can be made whether the user is eligible for a reward. Based on the analysis, it can be determined that the user falls into a preferred customer category for a particular computer game company and may be eligible for a discount or a free game or software, which can maintain good customer relationship, and to utilize user's characteristics for specialized direct advertisement. Once this user is identified as a preferred customer, he can be contacted by any type of communication method, e.g., email or pop-up message and be informed of his reward.

In addition to the above example, the home gamer may be a member of a multiplayer online game group, i.e., a user who plays a game in which many other users are involved. Characteristics, such as the scores and rankings of each and every user may be collected and forwarded at scheduled or random points in time. Based on an analysis of the forwarded data, users may compete against each other, e.g., to reach a particular threshold score, and then be contacted to receive a reward, for example, in form of a discount for the next purchase.

### Example 2

### The Office Employee

An employee at an office may mostly work on text or word processing programs and/or spreadsheets and/or presentation, etc., e.g., preparing letters. Data characteristic of the number of letters prepared in a month may be collected. According to the invention, data may be collected without screening any confidential and internal office information. Further, based on the performance of the employee, it can be analyzed whether the employee is eligible for a reward. For example, a possible reward may be discount on a special training session regarding either the particular software the employee is using for her work, or perhaps any new product of the software manufacturer or of a competitor.

In addition to the above example, a group of employees may be performing similar work on a office computer network. Data may be collected related to work product, for example, client letters, internal memos, spread sheets, file management, i.e, the manner in which these documents are produced, and to the information contained in these documents. From the collected data, characteristic information, for example, number of spread sheets prepared and time spent on each spread sheet, can be recorded producing information as to the efficiency of this particular office network as compared to similar office networks. Based on the collected data, the office network owner can be contacted and informed about the office's efficiency and be rewarded with discounted training sessions to improve work efficiency, new software, etc.

### Example 3

### The PC Family

A four member family may use only one PC in the household. One user mostly uses the PC for online banking and home office activities; the second user spends his time surfing the web seeking new recipes for home cooking. A third user may use the PC for home work, e.g., word processing and reference searching the Internet. The fourth family member may use the PC mostly to download music and free games, thereby jeopardizing the computer's security and the safety of the each user's specific applications. Based on the present invention, user characteristics can be collected, such as information sought on the net, frequency of security sensitive programs used. The present invention could also detect programs that are not associated with the current user groups, for example, the sudden opening of a screening programs stemming from a Trojan horse. In this case the reward would be informing the users that a screening program has opened and how to remedy further damages.

Furthermore, since the first user also uses the PC for office type activities, the present invention would allow for monitoring the specific usage, i.e., how many work products the user creates in a certain time frame. The collected data can be used to evaluate if the user is eligible for an updated version and the reward may be a discount for the updated version.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for collecting user information, comprising:
collecting data associated with user input to a first user interface, when a first client associated with the first user interface is offline and a predetermined application hosted by the first client interacts with a user by accepting the user input; and
forwarding the collected data associated with user input from the first user interface, when the first client is online, the collected data being analyzed to determine characteristics of the user.

2. The method according to claim 1, wherein the collected data associated with user input that is input to the first user interface comprises data characteristic of the user input that is input to the first user interface.

3. The method according to claim 1, wherein the collected data associated with user input that is input to the first user interface comprises data characteristic of usage of the predetermined application.

4. The method according to claim 1, wherein the collecting data comprises at least one of:
monitoring at least one of keystrokes, screen touches, touchpad touches, mouse movements, mouse clicks, trackball movements, trackpoint clicks, light pen movements, joystick movements, joystick button clicks, gamepad touches, and analog stick movements; and
monitoring at least one of opening software, exiting software, powering peripheral devices, and a length of time of user input.

5. The method according to claim 1, wherein the collected data associated with user input that is input to the first user interface is compared with collected data associated with user input that is input to a second user interface associated with a second client.

6. The method according to claim 5, wherein the collected data associated with user input that is input to the first user interface and the collected data associated with user input that is input to the second user interface is used to determine a reward for the user based on the comparison.

7. The method according to claim 1, wherein the collected data associated with user input that is input to the first user interface is used to generate a score that is compared with a predetermined threshold.

8. The method according to claim 7, wherein the collected data associated with user input that is input to the first user interface is used to determine a reward for the user based on the comparison.

9. The method according to claim 1, wherein the forwarding comprises generating a code segment based on the collected data associated with user input that is input to the first user interface.

10. The method according to claim 1, further comprising rewarding the first user based on the determined characteristics of the user.

11. A computer readable medium, comprising:
a collecting segment that collects data associated with user input, that is input to a first user interface, when a first client associated with the first user interface is offline; and
a forwarding segment that forwards the collected data associated with user input that is input to the first user interface, when the first client is online, the collected data associated with user input that is input to the first user interface being analyzed to determine characteristics of the user.

12. The computer readable medium according to claim 11, wherein the collecting segment collects data characteristic of the user input that is input to the first user interface.

13. The computer readable medium according to claim 11, wherein the collecting segment collects data characteristic of usage of the predetermined application.

14. The computer readable medium according to claim 11, wherein the collecting segment monitors at least one of: keystrokes, screen touches, touchpad touches, mouse movements, mouse clicks, trackball movements, trackpoint clicks, light pen movements, joystick movements, joystick button clicks, gamepad touches, and analog stick movements, opening software, exiting software, powering peripheral devices, and a length of time of user input.

15. The computer readable medium according to claim 11, wherein the collected data associated with user input that is input to the first user interface is forwarded to a second computer readable medium for comparison with data collected from a second client.

16. The computer readable medium according to claim 15, further comprising:
a rewarding segment that informs the first user of a reward based on the comparison.

17. The computer readable medium according to claim 11 further comprising:
a score generating segment that generates a score based on the collected data associated with user input that is input to the first user interface.

18. The computer readable medium according to claim 17 further comprising:
a score comparing segment that compares the score with a predetermined threshold.

19. A device, comprising:
at least one user interface,
a collector that collects data associated with user input to the at least one user interface, when the device is offline, and
a forwarder that forwards the collected data associated with user input that is input to the first user interface, when the device is online, the collected data associated with user input that is input to the first user interface being analyzed to determine user characteristics.

20. The device according to claim 19, wherein the collector collects data characteristic of the user input that is input to the at least one user interface.

21. The device according to claim 19, wherein the collector collects data characteristic of usage of a predetermined application.

22. The device according to claim 19, wherein the collector monitors at least one of keystrokes, screen touches, touchpad touches, mouse movements, mouse clicks, trackball movements, trackpoint clicks, light pen movements, joystick movements, joystick button clicks, gamepad touches, analog stick movements, opening software, exiting software, powering peripheral devices, and a length of time of user input.

23. The device according to claim 19, further comprising a score generator that compares scores with a predetermined threshold.

24. The device according to claim 23, further comprising an analyzer that analyzes the score with a predetermined threshold.
